(19) United States
(12) Patent Application Publication
(10) Pub. No.: US 2018/0081109 A1
(43) Pub. Date: Mar. 22, 2018

(54) Light Source, Backlight Module And Display Device

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventor: Pengbo XU, Shenzhen, Guangdong (CN)

(73) Assignees: Shenzhen China Star Optoelectronics Technology Co., Ltd., Shenzhen, Guangdong (CN); WUHAN CHINA STAR OPTOELECTRONICS TECHNOLOGY CO., LTD, Wuhan, Hubei (CN)

(21) Appl. No.: 15/027,263

(22) PCT Filed: Mar. 23, 2016
(86) PCT No.: PCT/CN2016/077112

§ 371 Date: Apr. 5, 2016

(30) Foreign Application Priority Data
Mar. 3, 2016 (CN) 201610120559.7

(51) Int. Cl. F21V 8/00

(52) U.S. Cl. CPC G02B 6/0031; G02B 6/0055; G02B 6/0088; G02B 6/0053; G02B 6/0051

(57) ABSTRACT

A light source, a backlight module and a display device. The light source includes a light emitting body and a light cavity. The light cavity comprises a light emitting portion, a transmission portion and a light outputting portion. The light emitting body is disposed in the light emitting portion; the transmission portion is connected with the light emitting portion and the light outputting portion; a light output port of the light outputting portion is disposed corresponding to a light guide plate, and a width of the light output port is not greater than a thickness of the light guide plate; a reflective material is provided in the light cavity, a portion of light emitted from the light emitting body directly enters light guide plate, and the other portion enters the light guide plate through reflecting by the reflective material one or more times. Accordingly, the light utilization rate is increased.

### BACKGROUND OF THE INVENTION

### 1. Field of the Invention

The present invention relates to a display technology field, and more particularly to a light source, a backlight module and a display device.

### 2. Description of Related Art

A current display device such as a backlight source of a cell phone usually includes a light source LED (Light-Emitting Diode), a light guide plate, a reflective sheet, a diffusion sheet and so on. Wherein, the light source LED and the light guide plate are disposed correspondingly such that the light emitted from the light source LED can enter the interior of the light guide plate to guide the light. The reflective sheet is disposed at a bottom of the light guide plate for reflecting the light into the light guide plate. The diffusion sheet is disposed above the light guide plate for uniforming the light emitted from the light guide plate and increase the brightness. For matching with the size of the light source LED, a terminal of the current light guide plate closed to the light source LED is disposed as a bell structure in order to completely receive the light emitted from the light source LED. Furthermore, in order to prevent from leaking light, a black PET (Polyethylene Terephthalate, High polymer) is disposed at the bell structure for absorbing the light emitted from the light source LED.

Because a terminal of the light guide plate is disposed as a bell structure, the manufacturing process of the light guide plate is limited. On the other hand, because the black PET material is used for absorbing light, the light utilization rate is decreased.

### SUMMARY OF THE INVENTION

The main technology problem solved by the present invention is to provide a light source, a backlight module and a display device, which can increase the light utilization rate, and decrease the production difficulty of the light guide plate.

In order to solve the above technology problem, a technology solution adopted by the present invention is to provide a light source, comprising: a light emitting body used for emitting light; and a light cavity comprising a light emitting portion, a transmission portion and a light outputting portion, wherein the light emitting body is disposed in the light emitting portion; the transmission portion is connected with the light emitting portion and the light outputting portion; a light output port of the light outputting portion is disposed corresponding to a light guide plate, and a width of the light output port is not greater than a thickness of the light guide plate; a reflective material is further provided in the light cavity, a portion of light emitted from the light emitting body directly enters the light guide plate, and the other portion of the light emitted from the light emitting body enters the light guide plate through reflecting by the reflective material one or more times.

Wherein, the width of the light outputting portion is gradually decreased from a terminal of the light outputting portion closed to the transmission portion to the light output port.

Wherein, the light emitting portion is gradually decreased from a terminal of the light emitting portion closed to the transmission portion to a terminal of the light emitting portion away from the transmission portion.

In order to solve the above technology problem, another technology solution adopted by the present invention is to provide a backlight module, wherein the backlight module includes a light source and a light guide plate, and the light source comprises: a light emitting body used for emitting light; and a light cavity comprising a light emitting portion, a transmission portion and a light outputting portion, wherein the light emitting body is disposed in the light emitting portion; the transmission portion is connected with the light emitting portion and the light outputting portion; a light output port of the light outputting portion is disposed corresponding to a light guide plate, and a width of the light output port is not greater than a thickness of the light guide plate; a reflective material is further provided in the light cavity, a portion of light emitted from the light emitting body directly enters the light guide plate, and the other portion of the light emitted from the light emitting body enters the light guide plate through reflecting by the reflective material one or more times.

Wherein the width of the light outputting portion is gradually decreased from a terminal of the light outputting portion closed to the transmission portion to the light output port.

Wherein, the light emitting portion is gradually decreased from a terminal of the light emitting portion closed to the transmission portion to a terminal of the light emitting portion away from the transmission portion.

Wherein, the light guide plate is a plate-shaped structure.

Wherein, the backlight module further includes a reflective sheet, and the reflective sheet is disposed below the light guide plate for reflecting an incident light back to the light guide plate.

Wherein, the backlight module further includes an optical film group disposed above the light guide plate, and the optical film group is used for diffusing and uniforming light emitted from the light guide plate.

In order to solve the above technology problem, another technology solution adopted by the present invention is to provide a display device, wherein, the display device includes a backlight module and a display panel disposed above the backlight module, the backlight module includes a light source and a light guide plate, and the light source comprises: a light emitting body used for emitting light; and a light cavity comprising a light emitting portion, a transmission portion and a light outputting portion, wherein the light emitting body is disposed in the light emitting portion; the transmission portion is connected with the light emitting portion and the light outputting portion; a light output port of the light outputting portion is disposed corresponding to a light guide plate, and a width of the light output port is not greater than a thickness of the light guide plate; a reflective material is further provided in the light cavity, a portion of light emitted from the light emitting body directly enters the light guide plate, and the other portion of the light emitted from the light emitting body enters the light guide plate through reflecting by the reflective material one or more times.

Wherein, the width of the light outputting portion is gradually decreased from a terminal of the light outputting portion closed to the transmission portion to the light output port.

Wherein, the light emitting portion is gradually decreased from a terminal of the light emitting portion closed to the transmission portion to a terminal of the light emitting portion away from the transmission portion.

Wherein, the light guide plate is a plate-shaped structure.

Wherein, the backlight module further includes a reflective sheet, and the reflective sheet is disposed below the light guide plate for reflecting an incident light back to the light guide plate.

Wherein, the backlight module further includes an optical film group disposed above the light guide plate, and the optical film group is used for diffusing and uniforming light emitted from the light guide plate.

The beneficial effect of the present invention is: comparing to the conventional art, the light source includes a light emitting body and a light cavity. Wherein, the light emitting body is used for emitting light, and the light cavity comprises a light emitting portion, a transmission portion and a light outputting portion. The light emitting body is disposed in the light emitting portion; the transmission portion is connected with the light emitting portion and the light outputting portion; a light output port of the light outputting portion is disposed corresponding to a light guide plate, and a width of the light output port is not greater than a thickness of the light guide plate; a reflective material is provided in the light cavity, a portion of light emitted from the light emitting body directly enters light guide plate, and the other portion enters the light guide plate through reflecting by the reflective material one or more times. Accordingly, the light utilization rate is increased. Therefore, the light of the light source can be fully utilized through the reflective material, which increases the light utilization rate.

### BRIEF DESCRIPTION OF THE DRAWINGS

FIG. 1 is a schematic structure diagram of a backlight module provided by an embodiment of the present invention; and

FIG. 2 is a schematic structure diagram of a display device provided by an embodiment of the present invention.

### DETAILED DESCRIPTION OF THE PREFERRED EMBODIMENT

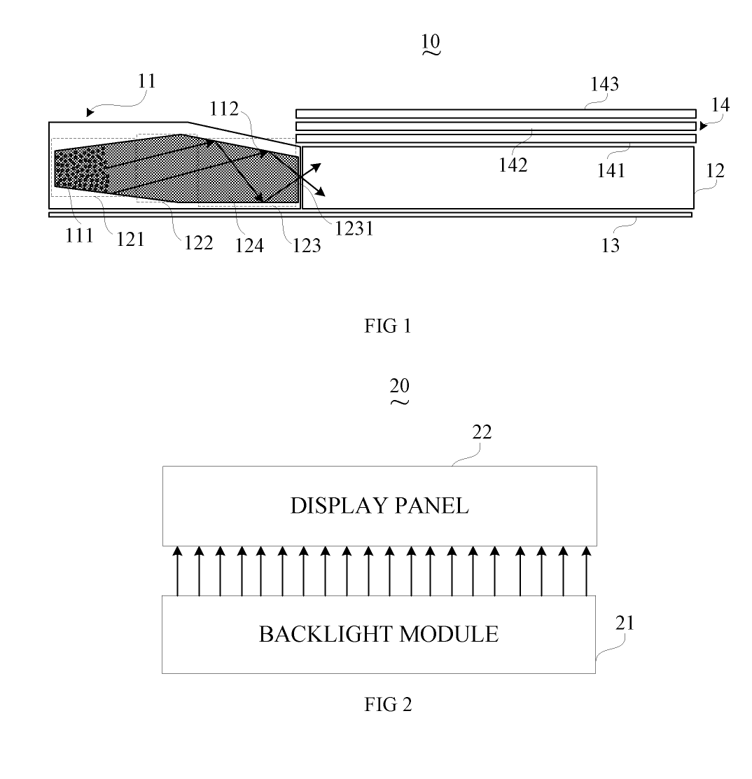

With reference to FIG. 1, and FIG. 1 is a schematic structure diagram of a backlight module provided by an embodiment of the present invention. As shown in FIG. 1, the backlight module 10 of the present embodiment includes a light source 11 and a light guide plate 12.

Wherein, the light source 11 includes a light emitting body 111 and a light cavity 112.

The light emitting body 111 is used to emit light.

The light cavity includes a light emitting portion 121, a transmission portion 122 and a light outputting portion 123. Wherein, the light emitting body 111 is disposed in the light emitting portion 121. Specifically, the light emitting body 111 is disposed at a terminal of the light emitting portion 121 away from the transmission portion 122. In another embodiment, for example, in a large-sized display device, if the number of the light emitting body 111 is required to be more, the light emitting body 111 can be evenly distributed in the light emitting portion 121.

The transmission portion 122 is connected with the light emitting portion 121 and the light outputting portion 123. The transmission portion 122 is used to transmit the light emitted from the light emitting portion 121 to the light outputting portion 123.

A light output port 1231 of the light outputting portion 123 is disposed corresponding to a light guide plate 12, and a width of the light output port 1231 is not greater than a thickness of the light guide plate 12 such that the light outputted from the light output port 1231 can completely enter into the light guide plate 12 so as to prevent the light from leaking out of the light output port 1231.

Inside the light cavity 12, a reflective material 124 is further provided. A portion of the light emitted from the light emitting body 111 directly enters the light guide plate 12, the other portion of the light emitted from the light emitting body 111 enters the light guide plate 12 through reflecting by the reflective material 124 one or more times.

Therefore, the light of the light source 11 can be fully utilized through the reflective material 124, which increases the light utilization rate. From an optical simulation experiment, when an input energy of the backlight module of the current technology is 1 W, a utilized energy is 0.70194 W. When an input energy of the backlight module of the backlight module 10 of the present embodiment is 1 W, a utilized energy is 0.87651 W. Therefore, comparing to the backlight module of the current technology, the backlight module 10 of the present embodiment can increase a light utilization rate about 17%.

In the present embodiment, the width of the light outputting portion 123 is gradually decreased from a terminal of the light outputting portion 123 closed to the transmission portion 122 to the light output port 1231. That is, the width of the light outputting portion 123 is gradually decreased from a terminal of the light outputting portion 123 away from the light guide plate 12 to a terminal of the light outputting portion 123 closed to the light guide plate 12 such that the terminal of the light outputting portion 123 closed to the light guide plate 12, that is, the width of the light output port 1231 is not greater than the thickness of the light guide plate. Furthermore, the light emitting portion 121 is gradually decreased from a terminal of the light emitting portion 121 closed to the transmission portion 122 to a terminal of the light emitting portion 121 away from the transmission portion 122.

Accordingly, the light source 11 forms a wedge-shaped structure which is large at a middle portion of the light source 11 and small at two terminals of the light source 11. Therefore, the light emitting portion 121 of the present embodiment will not be affected by the size of the light output port 1231 of the light outputting portion 123, and the light emitting portion 121 can still provide with a sufficient space to dispose the light emitting body 111. On one hand, a production difficulty of the light emitting portion 121 will not be increased. On the other hand, a problem that the light emitting body 111 cannot emit light normally because of insufficient space can be avoided. Furthermore, the width of the light output port 1231 of the light emitting portion 123 of the present embodiment can be small enough to match with the light guide plate 12. As described above, the width of the light output port 1231 is not greater than the thickness of the light guide 12 in order to prevent the light from leaking out.

Because the width of the light output port 1231 of the light outputting portion 123 can be disposed smaller than or equal to the thickness of the light guide plate 12, therefore, in the present embodiment, the light guide plate 12 is preferably a plate-shaped structure. A thicker thickness at the terminal of the light guide plate 12 closed to the light outputting portion 123 to form a bell structure is not required. Accordingly, the light guide plate 12 of the present embodiment can be made only by a thermoforming process, an additional process for machining the bell structure is not required so as to reduce the manufacturing the production difficulty of the light guide plate 12.

In summary, the backlight module 10 of the present embodiment can not only increase the light utilization rate, but also decrease the production difficulty of the light guide plate 12.

In the present embodiment, the backlight module 10 also includes a reflective sheet 13, and the reflective sheet 13 is disposed below the light guide plate 12 for reflecting incident light back to the light guide plate 12. Furthermore, in order to prevent the light from leaking out of the light source 11, the present embodiment further extends the reflective sheet 13 below the light source 11 for reflecting the light leaking out of the light source 11.

Furthermore, the backlight module 10 further includes an optical film group 14 disposed above the light guide plate 12, and the optical film group 14 is used for diffusing and uniforming light emitted from the light guide plate 12. Specifically, the optical film group 14 includes a diffusion film 141, a lower prism sheet 142 and an upper prism sheet 143. The diffusion film 141, the lower prism sheet 142 and the upper prism sheet 143 are sequentially disposed above the light guide plate 12. The diffusion film 141 is used for diffusing the light emitted from the light guide plate 12, the upper prism sheet 143 and the lower prism sheet 142 is used for uniforming the light emitted from the diffusion film 141 in order to increase brightness.

The embodiment of the present invention also provides a display device. With reference to FIG. 2, and FIG. 2 is a schematic structure diagram of a display device provided by an embodiment of the present invention. As shown in FIG. 2, the display device 20 of the present embodiment includes a backlight module 21 and a display panel 22 disposed above the backlight module 21. Wherein, the backlight module 21 is used for providing light for the display panel 22. The backlight module 21 of the present embodiment is the backlight module 10 described above, no more repeating.

Therefore, the light of the light source 11 can be fully utilized through the reflective material 124, which increases the light utilization rate, and decrease the production difficulty of the light guide plate 12.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A light source, comprising:
a light emitting body used for emitting light; and
a light cavity comprising a light emitting portion, a transmission portion and a light outputting portion, wherein the light emitting body is disposed in the light emitting portion; the transmission portion is connected with the light emitting portion and the light outputting portion;
a light output port of the light outputting portion is disposed corresponding to a light guide plate, and a width of the light output port is not greater than a thickness of the light guide plate; a reflective material is further provided in the light cavity, a portion of light emitted from the light emitting body directly enters the light guide plate, and the other portion of the light emitted from the light emitting body enters the light guide plate through reflecting by the reflective material one or more times.

2. The light source according to claim 1, wherein, the width of the light outputting portion is gradually decreased from a terminal of the light outputting portion closed to the transmission portion to the light output port.

3. The light source according to claim 2, wherein, the light emitting portion is gradually decreased from a terminal of the light emitting portion closed to the transmission portion to a terminal of the light emitting portion away from the transmission portion.

4. A backlight module, wherein the backlight module includes a light source and a light guide plate, and the light source comprises:
a light emitting body for emitting light; and
a light cavity comprising a light emitting portion, a transmission portion and a light outputting portion, wherein the light emitting body is disposed in the light emitting portion; the transmission portion is connected with the light emitting portion and the light outputting portion;
a light output port of the light outputting portion is disposed corresponding to a light guide plate, and a width of the light output port is not greater than a thickness of the light guide plate; a reflective material is further provided in the light cavity, a portion of light emitted from the light emitting body directly enters the light guide plate, and the other portion of the light emitted from the light emitting body enters the light guide plate through reflecting by the reflective material one or more times.

5. The backlight module according to claim 4, wherein the width of the light outputting portion is gradually decreased from a terminal of the light outputting portion closed to the transmission portion to the light output port.

6. The backlight module according to claim 5, wherein, the light emitting portion is gradually decreased from a terminal of the light emitting portion closed to the transmission portion to a terminal of the light emitting portion away from the transmission portion.

7. The backlight module according to claim 4, wherein, the light guide plate is a plate-shaped structure.

8. The backlight module according to claim 4, wherein, the backlight module further includes a reflective sheet, and the reflective sheet is disposed below the light guide plate for reflecting an incident light back to the light guide plate.

9. The backlight module according to claim 8, wherein, the backlight module further includes an optical film group disposed above the light guide plate, and the optical film group is used for diffusing and uniforming light emitted from the light guide plate.

10. A display device, wherein, the display device includes a backlight module and a display panel disposed above the backlight module, the backlight module includes a light source and a light guide plate, and the light source comprises:
a light emitting body used for emitting light; and
a light cavity comprising a light emitting portion, a transmission portion and a light outputting portion, wherein the light emitting body is disposed in the light emitting portion; the transmission portion is connected with the light emitting portion and the light outputting portion; a light output port of the light outputting portion is disposed corresponding to a light guide plate, and a width of the light output port is not greater than a thickness of the light guide plate; a reflective material is further provided in the light cavity, a portion of light emitted from the light emitting body directly enters the light guide plate, and the other portion of the light emitted from the light emitting body enters the light guide plate through reflecting by the reflective material one or more times.

11. The display device according to claim 10, wherein, the width of the light outputting portion is gradually decreased from a terminal of the light outputting portion closed to the transmission portion to the light output port.

12. The display device according to claim 11, wherein, the light emitting portion is gradually decreased from a terminal of the light emitting portion closed to the transmission portion to a terminal of the light emitting portion away from the transmission portion.

13. The display device according to claim 10, wherein, the light guide plate is a plate-shaped structure.

14. The display device according to claim 10, wherein, the backlight module further includes a reflective sheet, and the reflective sheet is disposed below the light guide plate for reflecting an incident light back to the light guide plate.

15. The display device according to claim 14, wherein, the backlight module further includes an optical film group disposed above the light guide plate, and the optical film group is used for diffusing and uniforming light emitted from the light guide plate.
